(19) United States
(12) Patent Application Publication
(10) Pub. No.: US 2006/0040185 A1
(43) Pub. Date: Feb. 23, 2006

(54) Holographic recording medium, holographic recording method and holographic information medium

(75) Inventor: Toshihisa Takeyama, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/201,815

(22) Filed: Aug. 11, 2005

(30) Foreign Application Priority Data
Aug. 18, 2004 (JP) JP2004-238064

(51) Int. Cl. G03H 1/04

(52) U.S. Cl. 430/1; 430/2; 359/3

(57) ABSTRACT

A holographic recording medium including: an first substrate; a holographic recording layer in which information can be holographic-recorded by entering information light and reference light from the first substrate side; and a second substrate, in that order, wherein the holographic recording medium satisfies the following relationship of (1) and (2):
0.2≦Dh/(D1+D2)≦1.0 (1)
1.0≦(Dh+D1+D2)≦3.0 [mm], (2) in the (1) and (2) D1 is the thickness of the first substrate, D2 is the thickness of the second substrate, and Dh is the thickness of the holographic recording layer, and wherein a hardness of the holographic recording layer that is measured by ISO 868 type A durometer is 10-70 degrees.

This application is based on Japanese Patent Application No. 2004-238064 filed on Aug. 18, 2004, in Japanese Patent Office, the entire content of which is hereby incorporated by reference.

### TECHNICAL FIELD

The present invention relates to a holographic recording medium that can be of a large capacity and can make high speed transfer possible, and further to a holographic recording method and to a holographic information medium on which information is recorded holographically.

### BACKGROUND

In recent years, high-speed exchanges of data in a large volume have been increased by the spread of Internet and by a shift to the broadband system, and a volume of data stored in each affiliated organ has been expanded rapidly because of extension of e-governments caused by promotion of the government of each country. In addition, recording media each having high storage capacity are expected to be needed in the future, by the spread of a high-definition television in a TV broadcast and by the spread of a digital terrestrial broadcast, and among them, next-generation optical recording media such as a blu-ray disc and a HDDVD disc are estimated to spread in the future. With respect to the next but one generation recording media, however, main products are absent, although various systems are proposed.

Among the next but one generation recording media, a memory system of a page type, especially, holographic recording is proposed to take the place of a conventional memory device, and it is watched with keen interest recently, because it has a high storage capacity and is of the system which makes random access and high speed transfer possible. With respect to this holographic recording, detailed explanations are described in some introductions (such as, for example, “Holographic Data Storage (Springer Series in Optical Sciences, Vol. 76)” written by Hans J. Coufal and others (Springer-Verlag GmbH & Co. KG, August in 2000)).

As a recording system in the holographic recording, a recording method using a holographic recording medium wherein transparent materials are arranged respectively on both sides of a holographic recording layer (for example, U.S. Pat. No. 5,719,691) and a recording method using a holographic recording medium equipped with a reflection surface arranged on one side of a holographic recording layer (for example, TOKKAI No. 2002-123949) are proposed.

In the basic principle of the holographic recording medium of this kind, the refractive index in a holographic recording layer in the medium is changed to record information by giving holographic exposure, and the change of the refractive index recorded in the medium is read to regenerate information, and there are proposed various materials as a material for the holographic recording layer, including the material using an inorganic material (for example, British Patent No. 9,929,953), the material using a compound that shows structural isomer with light (for example, TOKKAIHEI No. 10-340479), or the material using diffusion polymerization of photopolymer (for example, U.S. Pat. No. 4,942,112). Among these, in the material using photopolymer described in Patent Document 5, a volatile solvent is used in the case of manufacturing a composition for forming a recording layer, and therefore, the maximum thickness of the recording layer is limited to about 150 μm. In addition, volume shrinkage of 4-10% caused by polymerization has affected adversely the reliability in the case of regenerating recorded information.

There are proposed a composition for forming a holographic recording layer utilizing cation polymerization wherein no solvent is used and organization shrinkage is relatively less (for example, U.S. Pat. No. 5,759,721) and others, for improving the aforesaid weak points. However, the composition for forming a holographic recording layer has drawbacks wherein there is a fear that island-shaped portions formed, under the holographic exposure, by photopolymerization of monomer in the recording layer are moved undesirably, and a volume of liquid substance is expanded by changes of ambient temperatures in the apparatus, because those other than monomer that causes photo-cation polymerization are liquid substances.

To improve these drawbacks, radical polymerization is used for recording in holographic exposure, and there is proposed a composition (for example, U.S. Pat. No. 6,482,551) that forms a binder after forming a medium, for holding monomer that makes this radical polymerization before exposure to be possible, thus, it is possible to thicken a layer thickness of the holographic recording layer and to lessen the volume shrinkage by using the composition of this kind.

However, by an above-mentioned method, there was a case where the following failures were produced depending on the binder formed from a binder formation compound or the monomer in which radical polymerizaion is possible:
in the case of the formed binder is too hard, diffusion polymerization of the monomer in which radical polymerization is possible is not fully carried out in a holographic recording layer;
in the case of a binder is too soft, polymer which is made of a monomer which was formed of diffusion polymerization, and in which radical polymerization is possible moves in a holographic recording layer according to a storage condition;
furthermore, in the case of stresses, such as suppress strength and bending, are applied to media, the media itself deform, or polymer which is made of a monomer in which radical polymerization is possible moves; or
As a result, high energy is required for holographic during exposure or read-out of the recorded data cannot be performed.

The present invention is achieved in view of the above problem, an object of the present invention is to provide the holographic recording media and the holographic recording method sensitiveness was highly excellent in shelf life, and further provide holographic information media excellent in read-out of the information written in from the exterior to the stress.

### SUMMARY

An aspect of the invention is that:
a holographic recording medium including:
an first substrate;
a holographic recording layer in which information can be holographic-recorded by entering information light and reference light from the first substrate side; and
   a second substrate, in that order,
wherein the holographic recording medium satisfies the following relationship of (1) and (2):
   0.2≦Dh/(D1+D2)≦1.0 (1)
   1.0≦(Dh+D1+D2)≦3.0 [mm], (2)
in the (1) and (2) D1 is the thickness of the first substrate, D2 is the thickness of the second substrate, and Dh is the thickness of the holographic recording layer, and wherein a hardness of the holographic recording layer that is measured by ISO 868 type A durometer is 10-70 degrees.

### BRIEF DESCRIPTION OF THE DRAWINGS

FIG. 1 is a schematic diagram showing principle of operation of the measuring device which measures shrink rate.

FIG. 2 (a) is a sectional view showing the construction of layers included in the holographic recording medium and the holographic information medium.

FIG. 2 (b) is a sectional view showing the construction of layers included in the holographic recording medium and the holographic information medium.

FIG. 2 (c) is a sectional view showing the construction of layers included in the holographic recording medium and the holographic information medium.

### DETAILED DESCRIPTION OF PREFERRED EMBODIMENT

By the present invention, a holographic recording media and the holographic recording method with high sensitiveness and the excellent permanence, and holographic information media excellent in read-out of the information written in from the exterior to ability could be provided.

In the following, the holographic recording medium and the holographic information medium will be detailed.

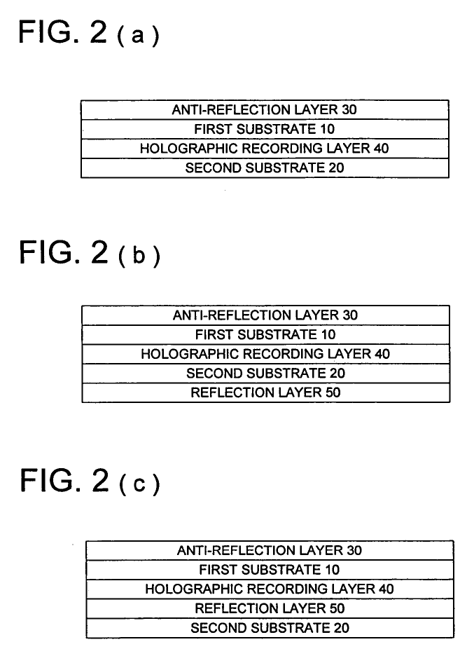

In the following, the construction of layers included in the holographic recording medium and the holographic information medium will be explained, using the FIG. 2(a), FIG. 2(b) and FIG. 2(c).

The FIG. 2(a), FIG. 2(b) and FIG. 2(c) are the sectional views showing the construction of layers included in the holographic recording medium and the holographic information medium.

As showing in the FIG. 2(a), FIG. 2(b) and FIG. 2(c), the holographic recording medium and the holographic information medium of this invention have the basically construction having a holographic recording layer (or a holographic information recording layer) 40 is sandwiched between the first substrate 10 and the second substrate 20. Furthermore an anti-reflection layer 30 may be provided on the first substrate 10.

Furthermore, it is possible to provide a reflection layer 50 on the second substrate 20 as shown in FIG. 2(b).

The reflection layer can be also provided between the holographic recording layer (or a holographic information recording layer) 40 and the second substrate 20 as shown in the FIG. 2(c).

In the holographic recording media of the present invention, the holographic recording layer is sandwiched between the first substrate and the second substrate, since it is required to perform a structural change and mass transfer of a molecule in the case of a holographic recording layer comprises the organic substance between the substrates mentioned later, generally the holographic recording layer comprises soft layers between substrates.

Therefore, it is preferable to satisfy the relationship of an above-mentioned formula (1), in the case of the thickness of a holographic recording layer is Dh, the thickness of the first substrate is D1 and the thickness of the second substrate is D2.

In the case of Dh/(D1+D2)>1.0, although it is possible to make a recording media thin, securing the coating thickness of a recording layer, the layer thickness of a recording layer becomes thick to the thickness of a substrate.

Moreover, since the following problems may arise, it is not preferable that: when the suppress strength is locally applied to of a recording media, too much deformation of a recording layer is easy to break out, and in the case of two kinds of stress with opposite directions are applied laterally to the first substrate and the second substrate respectively, a recording layer shifts aslant.

Moreover, in the case of 0.2>Dh/(D1+D2), it is not preferable because layer thickness of a holographic recording layer cannot be thickened, or even if the recording layer is thickended, there will be the need of thickening thickness of a substrate, the whole recording media becomes thick, in other words, the mass of a single recording media itself becomes heavy, and the load to the drive system of apparatus arises.

Moreover, in order to suppress the load to the drive system of the apparatus of a single recording media, it is preferable to make it the thickness of Dh+D1+D2≦3.0 [mm] represented in an above-mentioned formula (2), furthermore, also in order to suppress deformation of the media itself and deformation of a holographic recording layer, it is preferable to make it Dh+D1+D2≧1.0 [mm].

Furthermore, in the present invention, in the holographic recording media which satisfies an above-mentioned formula (1) and an above-mentioned formula (2), in order to further record also with low exposure energy as exposure energy at the time of entering information light and reference light from the first substrate side, and performing hologram recording in a holographic recording layer, it is preferable that the hardness measured with the durometer of type A specified by ISO 868 of a holographic recording layer without holographic recording is 70 or less degrees.

Moreover, in order to restore deformation of the recording layer locally produced in the case of suppress strength was applied to of some substrates, or in the case of the two kind of stress in opposed direction is lateraly applied to the first substrate and second substrate to the original shape, it is preferable that the hardness measured with the durometer of type A specified by ISO 868 is 10 degrees or more.

Next, the holographic recording layer which is the characteristic of the present invention, whose hardness measured with the durometer of type A specified by ISO 868 before recording a hologram is 10-70 degrees, is explained in full detail.

Although there will be no restriction in particular when the holographic recording layer of the present invention has the hardness before hologram recording in an above-mentioned range, in order to thicken a recording layer, after making a binder formation compound into the mode of media, it is preferable to make a bridge construct and to make it a binder.

In this case, it is more preferable that a holographic recording layer contains a binder formation compound, the compound which has the functional group which can be photopolymerized, and the photopolymerization initiator that can start the polymerization reaction of the compound which has the functional group in which that photopolymerization is possible.

A binder forming compound of this invention is characterized in that binder forming compounds each other do not polymerize or cross-link at the time of preparing a holographic recording composition but the binder forming compound is converted into a binder by polymerization or cross-linking at the time of preparing a holographic recording medium described below or after holographic exposure.

As such a binder forming compound, utilized can be at least one combination by appropriately selecting from (1) a compound provided with an isocyanate group and a compound provided with a hydroxyl group, (2) a compound provided with an isocyanate group and a compound provided with an amino group, (3) a compound provided with a carbodiimido group and a compound provided with a carboxyl group, (4) a compound provided with an unsaturated ester group and a compound provided with an amino group, (5) a compound provided with an unsaturated ester group and a compound provided with a mercaptan group, (6) a compound provided with a vinyl group and a compound provided with a silicon hydride group, (7) a compound provided with an oxirane group and a compound provided with a mercaptan group; (8) a compound provided with a group selected from oxirane, oxetane, tetrahydrofuran, oxepane, monocyclic actal, bicyclic acetal, lactone, cyclic orthoester and cyclic carbonate in the molecule and a thermal cationic polymerization initiator.

More preferably, a binder forming compound, utilized can be at least one combination by appropriately selecting from among above selection is at least one type selected from a compound provided with an isocyanate group and a compound provided with a hydroxyl group, or a compound provided with an oxirane group and a compound provided with a mercaptan group, which can be polymerized or cross-linked to be a binder at a mild condition.

A compound provided with an isocyanate group, which is employed at the time of cross-linking a compound provided with an isocyanate group and a compound provided with a hydroxyl group, is not specifically limited, however, more preferable is a compound provided with two or more isocyanate groups in the molecule with respect to sufficiently hold a compound provided with an ethylenic unsaturated bond as a photopolymerization composition detailed above after preparation of a holographic recording medium.

Specific examples of such a compound provided with an isocyanate group include such as 1,8-diisocyanate-4-isocyanatemethyl octane, 2-isocyanateethyl-2,6-diisocyanate caproate, benzene-1,3,5-triisocyanate, 1-methylbenzene-2,4,6-triisocyanate, 1,3,5-trimethylbenzene-2,4,6-triisocyanate, diphenylmethane-2,4,4′-triisocyanate, triphenylmethane-4,4′,4″-triisocyanate, bis(isocyanatetolyl)phenylmethane, dimethylene disiocyanate, tetramethylene diisocyanate, hexamethylene diisocyanate, 2,2-dimethylpentane diisocyanate, 2,2,4-trimethylpentane diisocyanate, decane isocyanate, ω,ω′-disiocyanate-1,3-dimethylbenzene, ω,ω′-disiocyanate-1,2-dimethylcyclohexane diisocyanate, ω,ω′-disiocyanate-1,4-diethylbenzene, isophorone diisocyanate, 1-methylhexyl-2,4-diisocyanate, ω,ω′-disiocyanate-1,5-dimethylnaphthalene, ω,ω′-disiocyanate-n-propylbiphenyl, 1,3-phenylene diisocyanate, 1-methylbenzene-2,4-diisocyanate, 1,3-dimethylbenzene-2,6-diisocyanate, naphthalene-1,4-diisocyanate, 1,1′-dinaphthyl-2,2′-diisosianate, biphenyl-2,4-diisocyanate, 3,3′-dimethylbiphenyl-4,4′-diisocyanate, diphenylmethane-4,4′-diisocyanate, 2,2′-dimethyldiphenylmethane-4,4′diisocyanate, dicyclohexylmethane-4,4′-diisocyanate, 3,3′-dimethoxydiphenylmethane-4,4′-diisocyanate, 4,4′-diethoxydiphenylmethane-4,4′-diisocyanate, tolylene diisocyanate, 1,5-naphthylene diisocyanate, xylylene diisocyanate and tetramethlenexylylene diisocyanate, in addition to these, a dimmer, a trimer or an adduct of each above-described isocyanate (such as a 2-mol-adduct of hexamehylene diisocyanate, a 3-mol-adduct of hexamehylene diisocyanate, a 2-mol-adduct of 2,4-tolylene diisocyanate and a 3-mol-adduct of 2,4-tolylenediisocyanate), an adduct of two or more types of isocyanates being different to each other selected from these isocyanates and adducts (such as an adduct of tolylene diisocyanate and trimethylol propane and an adduct of hexamethylene diisocyanate and trimethylol propane) of these isocyanates and dihydric or trihydric polyalcohols (such as diethylene glycol, polyethylene glycol, dipropylene glycol, polypropylene glycol, polytetramethylene glycol and trimethylol propane). These isocyanate compounds may be utilized alone or in combination of two or more types.

Herein, with respect to the isocyanate compounds described above, a holographic information medium, which is utilized in a state of finishing recording of whole information on a holographic recording medium, in which a recording layer comprising a holographic recording composition, detailed later is accumulated, is possibly exposed to variety of environmental temperatures at which the holographic information medium is placed under a fluorescent lamp or by the window or is allowed to stand similar to such as a CD and a DVD. Therefore, preferable are those to depress coloration of a recording layer under variety of conditions, and aliphatic isocyanate compounds among the above compounds are more preferable to depress such coloration.

Besides, if it does not prevent particularly the object of the present invention, the compound which has the isocyanate group used when making it a binder by carrying out the crosslinking with the combination of the compound which has the isocyanate group of (1), and the compound which has a hydroxyl group can be used without a restriction.

As a compound which has an isocyanate group, in order to make it a high-molecular weight binder by a crosslinking reaction with the compound which has two or more hydroxyl groups in above-mentioned molecular, the compound which has two or more hydroxyl groups in molecular is more preferable, and furthermore, the compound which has two or more alcoholic hydroxyl groups of an aliphatic sries in molecular is more preferable in order to make easy to control the rigidity measured with durometer.

Such compounds provided with at least two alcoholic hydroxyl groups in the molecule include such as diethylene glycol, triethylene glycol, polyethylene glycol, dipropylene glycol, tripropylene glycol, polypropylene glycol, 2,2-dimethyl-1,3-propanediol, 2,2-diethyl-1,3-propanediol, 2-butyl-2-ethyl-1,3-propanediol, 1,2-butanediol, 1,4-butanediol, polytetramethylene glycol, 1,5-pentanediol, 2-methyl-2,4-pentanediol, 3-methyl-1,5-pentanediol, 1,6-hexanediol, 2-ethyl-1,3-hexanediol, 2,5-dimethyl-2,5-hexanediol, 1,10-decanediol, 1,4-cyclohexanediol, glycerin, 1,2,6-hexanetriol, trimethylolethane, trimethylolpropane, pentaerythritol and sorbitol, in addition to these, alcohols in which the above-described compounds provided with at least two alcoholic hydroxyl groups in the molecule are modified with bihydric alcohols such as ethylene glycol, diethylene glycol, triethylene glycol, polyethylene glycol, propyrene glycol, dipropylene glycol, tripropylene glycol, polypropylene glycol and polytetramethylene glycol. Herein, these compounds provided with at least two alcoholic hydroxyl groups in the molecule may be utilized alone or in combination of two or more types.

The molecular weight of a compound provided with at least two aliphatic type alcoholic hydroxyl groups in the molecule is preferably 100-2000 taking into consideration volatility of the compound itself and compatibility or solubility with a compound provided with an ethylenic unsatulated bond, a compound provided with a functional group which can perform cationic polymerization or a photopolymerization initiator, and the addition amount of a compound provided with at least two aliphatic type alcoholic hydroxyl groups in the molecule cannot be defined ununequivocally with respect to the types and addition amount of an isocyanate compound as an essential component described above, however, is generally in a range of 0.3≦N/M≦1.5 and more preferably 0.5≦N/M≦1.5, when a mol number of isocyanate groups being present in a holographic recording composition of a compound provided with an isocyanate group is N [mol] and a mol number of hydroxyl groups being present in a holographic recording composition of the aforesaid compound provided with an alcoholic hydroxyl group is M [mol], with respect to compatibility and control of cross-linking reaction.

It is preferable that there is a difference between a reflective index of the binder formed by reacting a binder forming compound and a reflective index of the photopolymerized compound formed by photopolymerizing a compound which has a functional group being capable of photopolymerization without a practical problem including reduction of transmission and increasing haze.

Particularly, A compound provided with an ethylenic unsaturated bond as a compound has a functional group being capable of photopolymerization is easy to obtain a high-reflective index compound having the reflective index of more than 1.55.

In this case, it is preferable that selecting a binder compound so that the refractive index of a binder formed by the binder forming compound is less than a refractive index of a polymerized compound formed by polymerization of the photopolymerizable compound having the functional group being capable to photopolymerize.

Further, for the purposes of such as to control compatibility and viscosity at the time of preparation of a holographic recording layer composition and to control dispersion polymerization at the time of holographic exposure, a compound provided with a (meth)acryloyl group having a refractive index of less than 1.55 may also be added in a range of not disturbing the purpose of providing a refractive index difference between a binder formed from a binder forming compound and a diffusion polymerization product of a compound provided with an ethylenic unsaturated bond.

Furthermore, the compound which has ethyleny unsaturated bonding in the intramolecular mentioned above from a point of the ease of carrying out of the mass transfer at the case of hologram recording and which it has at least one or more pieces is liquefied, or it is preferable that a melting point is 60 degrees Celsius or less, and these compounds may be used by a kind independent and may use two or more sorts altogether.

Furthermore, it is ordinarily preferable that those compounds are 1.0 wt % or more and 30 wt % or less in the composition for holographic recording, and it is more preferable to make it 4.0 more wt % or more and 20 wt % or less.

As a photopolymerization initiator to photopolymerize a compound provided with an ethylenic unsaturated bond, in addition to the aforesaid compounds, utilized in combination may be commonly known conventional photopolymrization initiators such as benzoine and derivatives thereof, carbonyl compounds such as benzophenone, azo compounds such as azobisbutyronitrile, sulfer compounds such as dibenzothiazolylsulfide, peroxides such as benzoyl peroxide, halogen compounds such as 2-tribromomethane sulfonyl-pyridine, quartenary ammonium salts or substituted or unsubstituted diphenyliodonium salts, onium compounds such as a triphenylsulfonium salt, bisimidazol compounds such as 2,2-bis(o-chlorophenyl)-4,4′,5,5′-tetraphenylbiimidazol.

The well-known photopolymerization initiator represented by the metal □ complex containing iron arene complexes such as (η6-cumene) (η5-cyclopentadienyl) iron (1+) hexafluorophosphate, and titanocene complexes, such as di-η(5)-cyclopentadienyl bis [2,6-difluoro-3-(pyrrole-1-yl) phenyl] titanium (IV), and the complex with borate anion of cationic dye can be suitably chosen and used.

In these, at least one sort of compounds particularly chosen from a bis imidazole compound, a metal n complex, and a complex with borate anion of cationic dye are more preferable from the field of sensitiveness or stability. Furthermore, particularly in a metal n complex, an iron arene complex is more preferable.

Furthermore, when the exposure light source wavelength used for holographic exposure described below does not have absorption to the wavelength of the laser light source used for holographic exposure of that photopolymerization initiator, or has very small absorption though it has the absorption, it is more preferable that it is used together with the sensitizing dye for carrying out wavelength sensitization of the spectrum wavelength of a photopolymerization initiator.

Herein, sensitizing dyes to spectrally sensitize the photopolymerization initiators utilized here include variety of dyes well known in the art, and for example, variety of dyes such as cumalin derivatives, methine derivatives, polymethine derivatives, triarylmethane derivatives, indoline derivatives, azine derivatives, thiazine derivatives, xanthene derivatives, thioxanthene derivatives, oxazine derivatives, acrydine derivatives, cyanine derivatives, carbocyanine derivatives, merocyanine derivatives, hemicyanine derivatives, rhodacyanine derivatives, azamethine derivatives, styryl derivatives, pyrylium derivatives, thiopyrylium derivatives, porphyradine derivatives, porphyrin derivatives, phthalocyanine derivatives and pyrromethene derivatives can be utilized alone or appropriately in combination of two or more types.

As specific examples of such a photopolymerization initiator or a sensitizing dye, utilized by suitable selection can be those described, for example, in U.S. Pat. Nos. 5,027,436, 5,096,790, 5,147,758, 5,204,467, 5,256,520 and 6,011,180; European Patent Nos. 255,486, 256,981, 277,915, 318,893, 401,165 and 565,488; JP-A Nos. 2-236553, 5-46061, 5-216227, 5-247110, 5-257279, 6-175554, 6-175562, 6-175563, 6-175566, 6-186899, 6-195015, 6-202540, 6-202541, 6-202543, 6-202544, 6-202548, 6-324615, 6-329654, 7-13473, 7-28379, 7-84502, 7-84503, 7-181876, 9-106069, 9-309907, 2002-60429, 2002-62786, 2002-244535 and 2002-296764.

The above-described photopolymerization initiator to photopolymerize a compound provided with an ethylenic unsaturated bond cannot be ununequivocally defined depending on the molecular weight of a photopolymerization initiator or the occupying ratio of ethylenic unsaturated bonds in a compound provided with an ethylenic unsaturated bond, however, in general, is preferably utilized in a range of 0.01-25 weight parts based on a compound provided with an ethylenic unsaturated bond. Further, a sensitizing dye which can spectrally sensitize a photopolymerization initiator cannot be ununequivocally defined depending on the molecular weight or mol absorbance of a dye itself, however, in general, is preferably utilized in a range of 0.01-25 weight parts based on a photopolymerization initiator.

Furthermore, in addition to an above-mentioned component, in the range which does not prevent the object of the present invention, various additives, such as a catalyser for constructing a bridge or polymerizing a binder formation compound, a thermostabilizer, a series moving agent, a porosity agent, or a compatibilizer, can be selected as a holographic recording layer timely, and can be used for it.

Moreover, in order to depend for the thickness Dh of a holographic recording layer on the diffraction efficiency of a recording layer, a dynamic range, spatial resolution, etc., it is not generally decided, but it is ordinarily 0.2-1.5 mm.

In the present invention, it is more preferable to carry out flood exposure of the holographic recording layer which holographic recording has not accomplished in the holographic recording layer which comprised above-mentioned compositions and hardness measured with the durometer of type A specified by ISO 868 after carrying out photopolymerization of the compound which has at least one or more functional groups which are included in a holographic recording layer, and which can be photopolymerized is made into the range of 80 or less degrees 15 degrees or more.

It allows that deformation of the recording layer produced in the case of the stress of a substrate to which suppress strength is applied to in part, or a lateral direction is opposed with the first substrate and second substrate is applied locally can be restored to the original shape.

Next, the first substrate and second substrate which are the essential structural element of the present invention are explained in full detail.

The first substrate with which the information light used for the recording media of the present invention and reference light are irradiated can be particularly used without a restriction, when transmittance is high and neither dimensional stability nor deflection is generated in environmental temperature to the wavelength of the light irradiated.

It is more preferable that the total light transmittance of 3 mm thickness as which the first substrate is further specified by ASTM D1003 to the wavelength of the light irradiated since transmittance is high is 90% or more, as such a substrate, the following can be selected timely and can be used:
glass base materials, such as quartz glass, soda glass, potash glass, lead crystal glass, boro silicate glass, almino silicate glass, titanium crystal glass, or glass ceramics,
plastics base materials, such as polymethylmethacrylate, bisphenol A type polycarbonate, resin that has a cyclic olefin as a monomeric unit, resin which has 1,1-bis (4 hydroxyphenyls) cyclohexane as a monomeric unit, resin which has 1,1-bis (4 hydroxyphenyls)-3,3,5-trimethyl cyclohexane as a monomeric unit.

Moreover, in the case of it uses resin as the first substrate of the present invention, it is preferable to make glass transition temperature into 100-250 degrees Celsius because of the problem of the bridge construction condition for forming a binder from the binder formation compound further explained in full detail by mechanical strength or the above-mentioned, and the molding conditions for molding a substrate further.

Next, the anti-reflective layer on the first substrate where information light and reference light enter into the holographic recording medium will be explained in detail.

In order to raise the efficiency of the entering light, it is preferable that the anti-reflective layer is provided on the first substrate so that the reflectance is 0.01-1.0% when an incident light enters from a perpendicular right angle of 90 degrees using the same light source as an incident light.

When a refractive index is lower than the refractive index of the first base material, there is no restriction particularly for an antireflection layer, it is more preferable of using the inorganic metal fluoride including AlF3, MgF2, AlF3, MgF2 and CaF2, the homopolymer containing fluorine atoms which includes vinylidene fluoride and a teflon (registered trademark), the copolymer, the graft polymer, the block polymer, organic fluorides such as a denaturation polymer embellished by the functional group that contains a fluorine atom, and SiO2 since the refractive index becomes lower.

Herein, a method to provide a layer comprising a fluorine type compound on a substrate cannot be ununequivocally defined depending on types of a substrate or a fluorine type compound, however, commonly known methods such as a sol-gel method, a vacuum evaporation method, a sputtering method, a DVD method or a coating method, or methods described in JP-A Nos. 7-27902, 2001-1232-64 and 2001-264509 by suitable selection.

Furthermore, the multilayered antireflection film which laminated two or more low-refractive-index layers used for acid resisting, such as a plastic lens and a light element, and high refractive index layers can also be conveniently used by the present invention. As such a multilayered antireflection film, lamination or method described in each official gazette of JP-A No. 5-142401, No. 5-249303, No. 6-3504, No. 6-331803, No. 7-35902, No. 7-253501, and No. 11-311702 etc. can be suitably chosen and used.

The thickness of such an anti-reflection layer is not ununequivocally defined depending on a surface treatment or materials of a substrate, however, it is generally in a range of 0.001-20 μm and preferably in a range of 0.005-10 μm.

The second substrate which is the essential structural element of the present invention can be used by selecting the substrate explained in full detail with the first above-mentioned substrate timely.

Moreover, it is preferable that the relationship of the thickness D1 of the field of the energy loss of holographic during exposure to the first substrate and the thickness D2 of the second substrate is D1 □D2.

Moreover, in order to secure the flatness of a recording media, it is more preferable to make the ratio of the thickness of D1 and D2 into the range of 0.20 □D1/D2 □1.00.

Moreover, when a light enters from the first substrate side and information reading is performed from the second substrate side to a holographic recording medium and holographic information medium which are used for U.S. Pat. No. 5,838,467, and holographic recording and the regenerative apparatus of each specification of No. 6,700,686, the single layer antireflection film or the multilayer antireflection layer may further be arranged on the surface of second substrate provided on the holographic recording layer, in other words, to side with the detective section for detecting a light.

On the other hand, the shape of a recording medium is not specifically limited provided being suitable to a holographic recording-reproducing device utilized for said recording medium, however, a disk-form is preferred when it is utilized in a device described in such as U.S. Pat. No. 5,719,691 and JP-A No. 2002-123949, and a card form is preferred when it is utilized in a device described in such as World Patent Publication No. 99/57719.

The materials of such a reflection layer are not specifically limited provided that a desired reflectance is obtained, however, the layer can be generally accumulated by providing a thin layer comprising such as a metal on the substrate surface. To form such an reflection layer, a metal single crystal or polycrystal can be accumulated as a metal thin layer by a commonly known method such as a vacuum evaporation method, an ion plating method or a sputtering method, and as metals utilized to accumulate a metal thin layer, utilized can be alone or in combination of two or more types of metals such as aluminum, zinc, antimony, indium, selenium, tin, tantalum, chromium, lead, gold, silver, platinum, nickel, niobium, germanium, silicon, molybdenum, manganese, tungsten and palladium. The thickness of the metal thin layer is not limited provided that a desired reflectance can be obtained, however, is generally in a range of 1-3000 nm and preferably in a range of 5-2000 nm.

Further, in a holographic recording medium of this invention, physical patterns may be formed on one side surface of either substrate to track the position of information to be recorded or recorded information in the medium, similarly to commonly known optical disks such as a CD and a DVD, and as such patterns and methods to form the same, utilized by suitable selection can be those described, for example, in JP-A Nos. 2003-178456, 2003-228875, 2003-331464, 2004-126038, 2004-126040, 2004-126041 and 2004-127379, U.S. Pat. No. 6,625,100, U.S. Patent Publication Open to Public Inspection Nos. 2004/0042375 and 2004/0067419.

As a method to prepare the recording medium detailed above, a holographic recording layer forming composition is prepared by mixing a holographic recording layer composition under a safelight at ordinary temperature or while being appropriately heated, and a holographic recording layer forming composition is applied on the first substrate at ordinary temperature or while being appropriately heated after the composition has been degassed to depress polymerization inhibition at the time of holographic exposure, then the second substrate is laminated thereon to make a predetermined thickness of a recording layer without introducing bubbles, finally the edge portions are sealed resulting in preparation of a recording medium. Further, the first substrate and the second substrate are fixed under a safelight in a form so as to have a predetermined space, and a holographic recording layer composition is filled between the first substrate and the second substrate by means of injection molding not to introduce bubbles or by means of reduced pressure suction not to introduce bubbles, finally the edge portions are sealed resulting in preparation of a recording medium. Herein, under a safelight means an operation in a state of wavelengths of light which activates a photopolymerizatuin initiator being cut.

Furthermore, in the case of it uses the ends sealing agent on a ring, before it is provided, may be beforehand installed in a holographic recording stratification composition in the first substrate and/or second substrate, and it may be inserted between the first substrate and the second substrate afterwards.

Furthermore, the antireflection layer provided in the first substrate and second substrate may be laminated in advance, or may be installed after sealing the ends in the case of an antireflection layer is provided under a safelight.

Next, a method to record information on a holographic recording medium will be detailed.

A holographic recording method of the invention is characterized of including the steps of: reacting the binder forming compound for forming a binder; holographic exposing a surface of the anti-reflection layer of the holographic recording medium based on the information for generating activated species by activating the photopolymerization initiator; and diffusion polymerizing the photopolymerizable compound by the activated species in the holographic recording layer.

Generally, since a recording layer forming composition is prepared without a solvent to apply a thick layer, it is difficult to obtain a uniform thickness or to eliminate bubbles incorporated at the time of preparation of the composition in a solid or highly viscous composition.

Therefore, fluidity is required in a state of ordinary temperature or being heated when a recording layer forming composition is prepared. In particular, it is not preferable when this recording layer forming composition is a liquid and has a low viscosity at ordinary temperature, because flatness as a recording medium is hard to be secured or there is a possibility of position shifting of a polymer, which has been formed from a compound which has a functional group being capable of photopolymerization, in a recording layer.

Therefore, in a holographic recording medium containing the aforesaid essential component, it is possible to secure the flatness and to prevent the shift of a polymer, which has been formed by diffusion polymerization of a compound which has a functional group being capable of photopolymerization, in a holographic recording layer, by cross-linking a binder forming compound before holographic exposure.

Therefore, in a holographic recording medium containing the aforesaid essential component, it is possible to secure the flatness and to prevent the shift of a polymer, which has been formed by diffusion polymerization of a compound which has a functional group being capable of photopolymerization, in a holographic recording layer, by cross-linking a binder forming compound before holographic exposure.

Besides, Although bridge construction of an above-mentioned binder formation compound may be performed, in case it produces as a mode of a holographic recording media, or after producing as a mode of a holographic recording media, before writing information in a holographic recording media.

When deformation of the flatness of a recording media and the recording media at the case of handling is taken into consideration, it is preferable to carry out in the condition where the holographic recording stratification composition is filled up between the first substrate and the second substrate which were controlled by prescribed spacing in the process produced as a mode of a holographic recording media.

Moreover, there is particularly no restriction in the apparatus which records and reproduces the holographic recording media used for holographic data processing of the present invention, when it can be recorded and reproduced to the holographic recording media of the present invention. As such recording and apparatus to reproduce, each leaflet of followings can be cited, for example: each official gazette of each specification of U.S. Pat. No. 5,719,691, No. 5,838,467, No. 6,163,391, No. 6,414,296, the U.S. Patent application disclosure 2002/136143, JP-A No. 9-305978, No. 10-124872, No. 11-219540, JP-A No. 2000-98862, No. 2000-298837, No. 2001-23169, No. 2002-83431, No. 2002-123949, No. 2002-123948, and No. 2003-43904, international publications Nos. 99/57719, 02/05270, 02/75727.

It can use without restricting, particularly when it is the laser light source which can activate the photopolymerization initiator in a recording media and can read a holographic recording possibility and the recorded hologram as a laser light source used for recording described above and the apparatus to reproduce.

As such a light source, the semiconductor laser of a violet blue color region, an Ar laser, He—Cd laser, a frequency duplex YAG laser, He—Ne laser, Kr laser, the semiconductor laser of a near infrared region, etc. can be cited.

Moreover, a postscript may be added to the holographic recording media before recording, and a holographic recording media with little recorded information.

For this reason, when wavelength of the light source usually used for holographic recording is set to λ nm, a holographic recording media is kept and placed in a case or a cassette which can shade light with a wavelength of (λ+100) nm or below, preferably (λ+200) nm or below.

When exposing and recording a laser light on the above-mentioned holographic recording media, information is recorded by irradiating a laser light under unloading and shielding from a case or a cassette.

When those holographic information media set thickness of D2 and a holographic recording layer to Dh for the thickness of D1 and the second base material, the thickness of the first base material, in the holographic information media which a holographic information recording layer is sandwiched between the first base material and the second base material, and enter a read-out light from the first base material side, and read information from the second base material side, it is characterized that these holographic information media satisfies the above formula (1) and a formula (2), and has the hardness measured with the durometer of type A specified 10 degrees or more by ISO 868 of the holographic information recording layer of 80 or less degrees.

Moreover, the holographic information media which reproduce information by the light which reference light is entered from the first substrate side, and is reflected from the first substrate side are characterized by laminating the field which touches the holographic recording layer of the second substrate of above-mentioned information media, or the reflective layer of the opposite side whose reflectance is 80-99.5% at least at one side.

Moreover, it is preferable that an above-mentioned holographic information recording layer contains at least the binder resin with which information recording was formed from the binder formation compound, and polymer formed when the compound which has at least one functional group which can be photopolymerized polymerized with a photopolymerization initiator; and the above-mentioned holographic information recording layer has formed in the region which uses as a main ingredient the binder of the low refractive index formed from the binder formation compound, and the region whose polymer formed when the compound which has at least one functional group in which high photopolymerization of a refractive index is more possible than the region which uses a binder as a main ingredient polymerized with a photopolymerization initiator is a main ingredient; and
the antireflection layer that the reflectance to the wavelength of a read-out light becomes 0.01-1.0% at the surface side which enters the read-out light of the first substrate is laminated in order to read furthermore and to stop luminous energy.

It is preferable that an antireflection layer which serves as 0.01-1.0% of reflectance to the wavelength of a read-out light at a reverse surface with the surface which touches the holographic information recording layer of the second substrate is laminated in the case of it reads information from the second substrate side further.

It allows that these holographic information media have little irradiation energy of the read-out light of an information recording layer with which the information on the ordinary condition dealt with was recorded, and moreover, it does not almost have read-out deterioration with a regenerative apparatus also after a pressure is applied to the substrate of one side or both sides of information media partially or in whole area, or applied horizontal shearing stress to the first substrate and second substrate.

Even when both sides of the substrate are partially or entirely pressed and a horizontal shearing stress is applied to both the first and second substrates, there is little or no deterioration of the read-out at the reproduction device.

### EXAMPLES

The following is a description of concrete examples of this invention. However, the embodiments of this invention are not to be limited to these examples.

It is to be noted that the polyhydric alcohols (A1-A4) and the polyhydric isocyanate compounds (N1-N2) used when preparing a composition for forming a holographic recording layer are shown below.
A1: Polyoxypropylene glyceril ether (UNIOL TG-330 manufactured by NOF Corporation)
A2: Polyoxypropylene glyceril ether (UNIOL TG-1000 manufactured by NOF Corporation)
A3: Polypropylene glycol (UNIOL D-400 manufactured by NOF Corporation)
A4: Polypropylene glycol (UNIOL D-1000 manufactured by NOF Corporation)
N1: 2-isocyanate ethyl-2,6-diisocyanate caproate (LTI manufactured by Kyowa Hakko Kogyo Co., Ltd.)
N2: A polyisocyanate of hexamethylene diisocyanate (Duranate D-101 manufactured by Asahi Kasei corporation)

<Measurement of Hardness of the Composition for Forming the Holographic Recording Layer>

The composition for forming the holographic recording layer is prepared by a method described hereinafter is prepared and then the composition is used to fill a semi-transparent polyethylene container which has a rectangular configuration with the dimensions 10×10×30 mm. The container was then sealed and left for 2 weeks at 23° C. Next, the composition for forming the holographic recording layer which is hard and has a block-like configuration was taken from the polyethylene container and hardness at 10 locations was measured using an ISO 868 type A durometer (durometer SGS-719G manufactured by Shiro. Co., Ltd.), and the average value (Hb) was determined. It is to be noted that all of the above operation were performed in a safe light environment.

Also, the composition which was used to fill the semi-transparent polyethylene container which is configured as a rectangle having the dimensions 10×10×30 mm and then kept for 2 weeks at 23° C. in the sealed container, was left in the sealed polyester container for 24 hours under a sunshine fadometer with luminance of 70,000 lux at a temperature of 25° C. It was then left for four days in a room into which external light was allowed to enter. Next, the composition for forming the holographic recording layer which has a hard block-like configuration was taken from the polyethylene container and hardness at 10 locations was measured using an ISO 868 type A durometer (described above), and the average value (Ha) was determined.

(Compositions 1-13 for Forming the Holographic Recording Layers)

11.0 mg of sensitizing dye (having the structural formula 1 below) and 34.0 mg of a urethane hardener (Neostann U-600 manufactured by Nitto Kasei Co., Ltd.) were added to the polyhydric alcohols shown in Table 1 under a safe light and mixed and dissolved to thereby prepare Solution 1. 3.100 g of polyethylene glycol dimetacrylate (NK ester 14G manufactured by Shin-Nakamura Chemical Co., Ltd.), 6.900 g of EO denatured tribromophenyl acrylate (New Frontier BR-31 manufactured by Dai-ichi Kogyo Seiyaku Co., Ltd.) and 36.0 mg of 2,6-di(t-butyl)-4-methyl phenol were separately added to a polyhydric isocyanate in Table 1 and they were all mixed and dissolved to thereby prepare solution A. Next, 0.500 g of (η6-cumene) (η5-cyclopentadienyl) iron (1⁺) hexafluorophosphate was added and then the solution 1 which is described in the foregoing was added and final composition was degassed using nitrogen and then the gas component which is contained therein was removed using a supersonic washer and the compositions 1-13 for forming a holographic recording layer were thereby prepared.

Formula 1

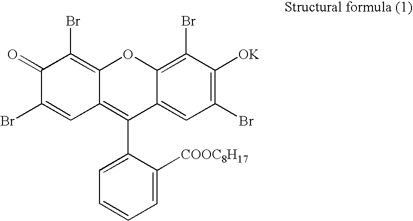

TABLE 1

| | Composition | | | | | | | | | |
|---|---|---|---|---|---|---|---|---|---|---|
| | for Forming | | | | | | | | | |
| | Holographic | Polyhydric | | Polyhydric Isocyanate | | | | Functional | Durometer | |
| | Recording | Alcohol | | Compound | | | | Group Mole | Hardness | |
| | Layer No. | Type | Amount | Type | Amount | Type | Amount | Ratio (NCO/OH) | Hb | Ha |
| Comparative Example | 1 | A1 | 37.599 | N1 | 25.943 | N2 | 25.943 | 1.00 | 70< | 80< |
| This Invention | 2 | A2 | 61.485 | N1 | 14.000 | N2 | 14.000 | 1.00 | 68 | 73 |
| This Invention | 3 | A3 | 46.783 | N1 | 10.675 | N2 | 32.024 | 1.00 | 62 | 66 |
| This Invention | 4 | A4 | 65.555 | N1 | 5.983 | N2 | 17.946 | 1.00 | 53 | 57 |
| This Invention | 5 | A4 | 66.263 | N1 | 5.805 | N2 | 17.416 | 0.96 | 52 | 56 |
| This Invention | 6 | A4 | 67.356 | N1 | 5.532 | N2 | 16.597 | 0.91 | 43 | 46 |
| This Invention | 7 | A4 | 68.293 | N1 | 5.298 | N2 | 15.893 | 0.85 | 34 | 37 |
| This Invention | 8 | A4 | 69.258 | N1 | 5.056 | N2 | 15.169 | 0.80 | 2 | 26 |
| This Invention | 9 | A4 | 70.251 | N1 | 4.808 | N2 | 14.425 | 0.75 | 13 | 16 |
| Comparative Example | 10 | A4 | 71.272 | N1 | 4.553 | N2 | 13.659 | 0.70 | <5 | <5 |
| This Invention | 11 | A4 | 64.314 | N1 | 3.596 | N2 | 21.575 | 1.00 | 55 | 59 |
| This Invention | 12 | A4 | 64.047 | N1 | 2.544 | N2 | 22.894 | 1.00 | 44 | 48 |
| This Invention | 13 | A4 | 62.731 | — | — | N2 | 26.754 | 1.00 | 25 | 28 |

<Preparation of the Holographic Recording Media>

(Preparation Method 1)

Amorphous polyolefin substrates (Zeonex 480R manufactured by Zeon Corporation with total light transmissivity of 92% and Tg=138° C.) with a diameter of 80 mm and a thickness of 0.5 mm (D1 and D2) in which one surface is subjected to antireflection treatment such that the reflectance due to incident light which is orthogonal to a wavelength of 532 nm is not greater than 0.3%, were used as the first substrate and the second substrate. Resin sheets with an outer diameter of 80 mm and inner diameter of 72 mm were placed as spacers on the surface of the first substrate that had not been subjected to antireflection treatment such that the thickness of the recording layers (Dh) are as shown in Table 2, and each composition for forming the holographic recording layer of Table 1 was placed on the first substrate. Next, surface of the second substrate that had not been subjected to antireflection treatment was pasted on the holographic recording layer composition such that no air layer was enclosed therebetween and the first substrate and the second substrate were pasted together via the spacer. Finally, the ends were sealed using a moisture curing adhesive, and holographic recording media was formed in which the binder forming compound is cross-linked under the cross-linking conditions shown in Table 2.

(Preparation Method 2)

One side of a glass with a diameter of 80 mm and a thickness of 0.5 mm (D11) was subjected to antireflection treatment such that the reflectance due to incident light which is orthogonal to a wavelength of 532 nm is 0.1%, to thereby prepare the first substrate. Meanwhile, one side of a substrate formed from bis-phenol A type polycarbonate with a diameter of 80 mm and a thickness of 0.5 mm (D2) (Lupilon H-4000 manufactured by Mitsubishi Engineering-Plastics Corporation) was subjected to aluminum vapor deposition such that the reflectance due to incident light which is orthogonal to a wavelength of 532 nm is not less than 90%, to thereby form the second substrate. Next, a resin sheet with an outer diameter of 80 mm and inner diameter of 72 mm is placed as a spacer on the surface of the foregoing first substrate that has not been subjected to antireflection treatment such that the recording layer thickness (Dh) is as shown in Table 3, and each composition for forming the holographic recording layer shown in Table 1 is placed on the first substrate. Next, the surface of the second substrate that has been subjected to aluminum vapor deposition is pasted on the composition for forming the holographic recording layer such that no air layer is enclosed therebetween and the first substrate and the second substrate are pasted together via the spacer. Finally, the ends are sealed using a moisture curing adhesive, and holographic recording media is formed in which the binder forming compound is cross-linked under the cross-linking conditions shown in Table 2.

TABLE 2

| | | | | Heat | | | |
|---|---|---|---|---|---|---|---|
| | | | Composition | Treatment | | Recording | |
| | | | for Forming | Conditions | | Layer | |
| | Holographic | | the Recording | Temperature | Time | Thickness | Dh/ |
| | Recording Media No. | Preparation Method | Layer No. | (° C.) | (hr) | Dh (mm) | (D1 + D2) |
| Comparative Example | Recording Media No. 1 | Preparation Method 1 | 1 | 20 | 72 | 0.50 | 0.50 |
| This Invention | Recording Media No. 2 | Preparation Method 1 | 2 | 20 | 72 | 0.50 | 0.50 |
| This Invention | Recording Media No. 3 | Preparation Method 1 | 3 | 20 | 72 | 0.50 | 0.50 |
| This Invention | Recording Media No. 4 | Preparation Method 1 | 4 | 20 | 72 | 0.50 | 0.50 |
| This Invention | Recording Media No. 5 | Preparation Method 1 | 5 | 20 | 72 | 0.50 | 0.50 |
| This Invention | Recording Media No. 6 | Preparation Method 1 | 6 | 20 | 72 | 0.50 | 0.50 |
| This Invention | Recording Media No. 7 | Preparation Method 1 | 7 | 20 | 72 | 0.50 | 0.50 |
| This Invention | Recording Media No. 8 | Preparation Method 1 | 8 | 20 | 72 | 0.50 | 0.50 |
| This Invention | Recording Media No. 9 | Preparation Method 1 | 9 | 20 | 72 | 0.50 | 0.50 |
| Comparative Example | Recording Media No. 10 | Preparation Method 1 | 10 | 20 | 72 | 0.50 | 0.50 |
| Comparative Example | Recording Media No. 11 | Preparation Method 2 | 1 | 20 | 72 | 0.50 | 0.50 |
| This Invention | Recording Media No. 12 | Preparation Method 2 | 2 | 20 | 72 | 0.50 | 0.50 |
| This Invention | Recording Media No. 13 | Preparation Method 2 | 3 | 20 | 72 | 0.50 | 0.50 |
| This Invention | Recording Media No. 14 | Preparation Method 2 | 4 | 20 | 72 | 0.50 | 0.50 |
| This Invention | Recording Media No. 15 | Preparation Method 2 | 5 | 20 | 72 | 0.50 | 0.50 |
| This Invention | Recording Media No. 16 | Preparation Method 2 | 6 | 20 | 72 | 0.50 | 0.50 |
| This Invention | Recording Media No. 17 | Preparation Method 2 | 7 | 20 | 72 | 0.50 | 0.50 |
| This Invention | Recording Media No. 18 | Preparation Method 2 | 8 | 20 | 72 | 0.50 | 0.50 |
| This Invention | Recording Media No. 19 | Preparation Method 2 | 9 | 20 | 72 | 0.50 | 0.50 |
| Comparative Example | Recording Media No. 20 | Preparation Method 2 | 10 | 20 | 72 | 0.50 | 0.50 |
| This Invention | Recording Media No. 21 | Preparation Method 2 | 11 | 20 | 72 | 0.50 | 0.50 |
| This Invention | Recording Media No. 22 | Preparation Method 2 | 12 | 20 | 72 | 0.50 | 0.50 |
| This Invention | Recording Media No. 23 | Preparation Method 2 | 13 | 20 | 72 | 0.50 | 0.50 |

(Recording and Evaluation of the Holographic Recording Media)

(Recording and Evaluation of the Holographic Recording Media 1)

The holographic recording media prepared as described above which were left for 1 week at 23° C. while being shielded from light, were used for recording on a set of different holograms in accordance with the procedures described in U.S. Pat. No. 5,719,691 or Japanese Patent Application Laid-Open 2002-123949, and measurement and evaluation of sensitivity (recording energy) as well as measurement and evaluation of the degree of deformation of the holographic recording media prior to holographic recording were performed using a method described hereinafter. The results obtained are shown in FIG. 3.

(Measurement of the Degree of Deformation)

The prepared holographic recording layers which were left for 1 week at a temperature of 23° C. while being shielded from light were subjected to holographic exposure having the digital pattern of an energy level of 0.1-30 mJ/cm² using a holographic preparation device applying each of the media which is equipped with Nd: YAG laser (532 nm). Next, the holographic recording media were left at a distance of 20 cm apart for one hour under a 20-watt white light fluorescent lamp. The recording media which were left under the white fluorescent lamp were read using a CCD with refracted light obtained by using Nd: YAG laser (532 nm) as the read-out light in a dark room, and the minimum amount of exposure for which a favorable digital pattern can be reproduced is measured as the sensitivity (S).

(Measurement of Degree of Deformation of Holographic Recording Media)

The prepared holographic recording media were left for 1 week at a temperature of 23° C. while being shielded from light, and the thickness da0 of the holographic recording media was measured in safe light environment using a micrometer (Micrometer MDC-25M manufactured by Mitutoyo Corporation). Next, a load of 250 g/cm² per unit of thickness was applied to the first substrate surface side of the holographic recording media having an area of 20 mm×20 mm for 120 minutes and then the degree of deformation were evaluated using the method described below given that thickness da1 and da60 respectively is the thickness of the holographic recording media 1 minute and then 60 minutes after the load was removed.
daa=[thickness of holographic recording media da0]−[thickness of holographic recording media 1 minute after the load was removed da1]
dab=[thickness of holographic recording media da0]−[thickness of holographic recording media 60 minutes after the load was removed da60]

TABLE 3

| | Holographic Recording | S | daa | dab |
|---|---|---|---|---|
| | Media No. | [mJ/cm²] | [μm] | [μm] |
| Comparative | Recording Media No. 1 | 4.3 | 0 | 0 |
| Example | | | | |
| This Invention | Recording Media No. 2 | 3.9 | 0 | 0 |
| This Invention | Recording Media No. 3 | 3.6 | 0 | 0 |
| This Invention | Recording Media No. 4 | 3.2 | 0 | 0 |
| This Invention | Recording Media No. 5 | 3.2 | 0 | 0 |
| This Invention | Recording Media No. 6 | 2.8 | 0 | 0 |
| This Invention | Recording Media No. 7 | 2.8 | 0 | 0 |
| This Invention | Recording Media No. 8 | 2.8 | 5 | 0 |
| This Invention | Recording Media No. 9 | 2.8 | 10 | 0 |
| Comparative | Recording Media No. 10 | 2.8 | 30 | 5 |
| Example | | | | |
| Comparative | Recording Media No. 11 | 2.3 | 0 | 0 |
| Example | | | | |
| This Invention | Recording Media No. 12 | 1.8 | 0 | 0 |
| This Invention | Recording Media No. 13 | 1.7 | 0 | 0 |
| This Invention | Recording Media No. 14 | 1.6 | 0 | 0 |
| This Invention | Recording Media No. 15 | 1.6 | 0 | 0 |
| This Invention | Recording Media No. 16 | 1.4 | 0 | 0 |
| This Invention | Recording Media No. 17 | 1.4 | 2 | 0 |
| This Invention | Recording Media No. 18 | 1.4 | 5 | 0 |
| This Invention | Recording Media No. 19 | 1.4 | 10 | 0 |
| Comparative | Recording Media No. 20 | 1.4 | 30 | 5 |
| Example | | | | |
| This Invention | Recording Media No. 21 | 1.5 | 0 | 0 |
| This Invention | Recording Media No. 22 | 1.3 | 0 | 0 |
| This Invention | Recording Media No. 23 | 1.5 | 5 | 0 |

From the table above, it can be seen that the recording media of this invention is a holographic recording media in which there is no loss of sensitivity and for which there is a force for restoration with respect to external stress.

(Evaluation of Holographic Recording Media 2)

The shrink resistance properties at the time of holographic exposure of the holographic recording media used for measuring sensitivity, diffraction rate contrast, degree of deformation of the holographic recording media are measured and evaluated and the results shown in Table 4.

(Evaluation of Shrink Resistance Properties at the Time of Holographic Exposure)

The shrink resistance properties at the time of holographic exposure were evaluated using the shrinkage rate which is measured by a method described hereinafter.

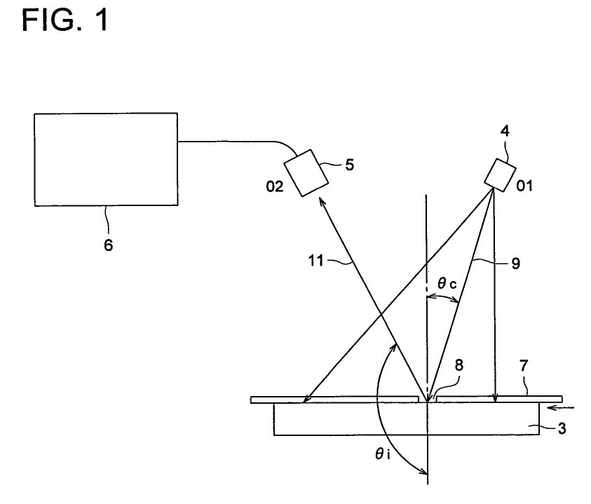

FIG. 1 is a schematic diagram showing principle of operation of the measuring device which measures shrink rate.

Namely, the emission point of the white illumination light source which illuminates the holographic recording media 3 which has been subjected to holographic exposure described above is 01, while the view point of the observer is 02. In the measuring device, the white illumination light source 4 has the emission point 01 while the spectrometer 5 has the view point 02. The spectrometer 5 is connected to the personal computer 6 and the upper surface of the holographic recording media 3 for which the luminance distribution of the spectral wavelength is to be measured has placed thereon a moveable pinhole plate 7 which has formed therein a pinhole 8 such that only some of the light can pass through. The movable pinhole plate 7 is configured so as to be moveable to suitably selected positions on the stage XY which is not shown.

That is to say, in the case where the moveable pinhole plate 7 is at the point P (I, J), the angle formed between the middle of the pinhole 8 and the white illumination light source is θc, and the angle with the spectrometer is θi. The region for the point P (I, J) of the holographic recording media 3 is illuminated with illumination 9 from the θc angle and reproduction light 11 exits from the θi angle direction. The reproduction light 11 is separated into its spectral components by the spectrometer 5, and the wavelength at which luminance is a peak is the reproduction wavelength λc at P (I,J). Using this relationship, θc, θi, and λc are measured at each point of the holographic recording media 3 while moving the movable pinhole plate 7.

Also, given that the shrinkage rate of the hologram at the point P (I, J) is M(I, J), the shrinkage rate M(I, J) of the hologram can be shown by the equation below given that the average refractivity of the light image recording layer prior to recording is nr and the average refractivity of the hologram after development is nc.
M(I,J)=−nc/nr·λr/λc·(cos θc−cos θi)/(cos θo−cos θr)

It is to be noted that in the above equation, θo is the angle of incidence of the holographic recording media, λr is the wavelength of the laser beam, and θr is the angle of incidence of the reference beam for the holographic recording media.

(Evaluation of the Refractivity Contrast)

The refractivity contrast is determined by diffraction efficiency which is measured using a method described in the following. The measurement of the diffraction efficiency is done by using an ART 25C spectrophotometer manufactured by JASCO Corporation, and a photomultimeter having a slit with a width of 3 mm is placed on the circumference of a circle having a radius of 20 cm with the sample at the center thereof. Light of a single color having a width of 0.3 mm is irradiated at an angle of 45° on the sample and the light diffracted from the sample is detected. The ratio of maximum value other than that for the regular reflection and the value obtained when the light entered directly without using the specimen was received, and ws used as the diffraction rate, and the refraction rate contrast (Δn) was determined from the diffraction rate of the hologram that was obtained.

(Measurement of Degree of Deformation of Holographic Recording Media after Recording)

The thickness db0 of the holographic recording media which was subjected to holographic exposure was measured using a micrometer (described in the foregoing). Next, a load of 500 g/cm² per unit of thickness was applied to the first substrate surface side of the holographic recording media having an area of 20 mm×20 mm and then it was left for 60 minutes and then the degree of deformation were evaluated using the method described below given that thickness db0.5 and db10 respectively is the thickness of the holographic recording media 0.5 minute and then 10 minutes after the load was removed.
dba=[thickness of exposed holographic recording media db0]−[thickness of holographic recording media 0.5 minute after the load is removed db0.5]
dbb=[thickness of the exposed holographic recording media db0]−[thickness of holographic recording media 10 minutes after the load is removed db10]

TABLE 4

| | Holographic | | | | |
|---|---|---|---|---|---|
| | Recording | Shrink | Δn | dba | dbb |
| | Media No. | rate (%) | (×10⁻³) | [μm] | [μm] |
| Comparative | Recording | 0.2 | 6.3 | 0 | 0 |
| Example | Media No. 1 | | | | |
| This Invention | Recording | 0.1 | 6.5 | 0 | 0 |
| | Media No. 2 | | | | |
| This Invention | Recording | 0.1 | 6.6 | 0 | 0 |
| | Media No. 3 | | | | |
| This Invention | Recording | 0.1 | 6.8 | 0 | 0 |
| | Media No. 4 | | | | |
| This Invention | Recording | 0.1 | 6.8 | 0 | 0 |
| | Media No. 5 | | | | |
| This Invention | Recording | 0.1 | 6.9 | 0 | 0 |
| | Media No. 6 | | | | |
| This Invention | Recording | 0.1 | 6.7 | 0 | 0 |
| | Media No. 7 | | | | |
| This Invention | Recording | 0.1 | 6.6 | 0 | 0 |
| | Media No. 8 | | | | |
| This Invention | Recording | 0.1 | 6.4 | 2 | 0 |
| | Media No. 9 | | | | |
| Comparative | Recording | 0.1 | 6.2 | 10 | 0 |
| Example | Media No. 10 | | | | |

From the table above, it can be seen that the recording media of this invention has little shrinkage during holographic exposure and even if a load is applied on the recording media the deformation is immediately restored to the original form.

<Evaluation of the Holographic Information Media>

(Evaluation of the Holographic Information Media 1)

The holographic recording media which was created in Table 4 and on which recorded information is fixed, is used as holographic information media and some of these are stored under conditions described hereinafter and reproduction of the digital pattern is evaluated by a method suitable for each information media immediately after storage and the difference in the minimum amount of exposure for which favorable reproduction of the digital pattern was possible and the degree of coloration were evaluated using a method described hereinafter, and the obtained results are shown in Table 5.

(Heat Resistance During Storage)

The holographic information media was stored for 2 weeks at 60° C. and the difference in minimum exposure sensitivity immediately after storage (ΔSh) was obtained.
Difference in minimum exposure sensitivity (ΔSh)=minimum exposure sensitivity after storage (S2h)−minimum exposure sensitivity prior to storage (S1h)

(Fading Resistance During Storage)

The holographic information media was stored for 4 days under a 70,000 lux sunshine fadometer at a temperature of 35° C. and difference in the minimum exposure sensitivity (ΔSw) immediately after storage was obtained.
Difference in minimum exposure sensitivity (ΔSw) minimum exposure sensitivity after storage (S2w)−minimum exposure sensitivity prior to storage (S1w)

(Evaluation of Coloration Level)

The holographic recording media used in Table 5 below were subjected to treatment under 70,000 lux sunshine fadometer for 5 minutes without undergoing holographic exposure and then subjected to heat treatment at 100° C. to thereby prepare the holographic information media. Next, the holographic information media was stored under conditions described hereinafter and the transmissivity and reflectance of each information media was measured immediately after using a spectrophotometer (U-4100 Spectrophotometer manufactured by Hitachi High-Technologies Corporation). It is to be noted that transmissivity is measured in the case where the holographic information media does not have a reflection layer, while the reflectance is measured from the first substrate side in the case where the holographic information media has a reflection layer.

(Heat Resistance During Storage)

The holographic information media was stored for 2 weeks at 60° C. and the difference in transmissivity at 400 nm immediately after storage (ΔTh) was obtained.
Difference in transmissivity (ΔTh)=Transmissivity or reflectance before storage (T1h)−Transmissivity or reflectance after storage (T2h).

(Fading Resistance During Storage)

The holographic information media was stored for 4 days under a 70,000 lux sunshine fadometer at a temperature of 35° C. and difference in transmissivity or reflectance at 400 nm immediately after storage (ΔTh) is obtained.
Difference in transmissivity (ΔTw)=Transmissivity or reflectance before storage (T1w)−Transmissivity or reflectance after storage (T2w)

TABLE 5

| | Holographic Information | Holographic Recording | ΔSh | ΔSw | ΔTh | ΔTw |
|---|---|---|---|---|---|---|
| | Media No. | Media No. | [mJ/cm²] | [mJ/cm²] | [%] | [%] |
| Comparative Example | Information Media No. 1 | Recording Media No. 1 | 0.1 | 0.2 | 0.2 | 0.3 |
| This Invention | Information Media No. 2 | Recording Media No. 2 | 0.1 | 0.2 | 0.2 | 0.3 |
| This Invention | Information Media No. 3 | Recording Media No. 3 | 0.1 | 0.2 | 0.2 | 0.3 |
| This Invention | Information Media No. 4 | Recording Media No. 4 | 0.1 | 0.2 | 0.2 | 0.3 |
| This Invention | Information Media No. 5 | Recording Media No. 5 | 0.1 | 0.2 | 0.2 | 0.3 |
| This Invention | Information Media No. 6 | Recording Media No. 6 | 0.1 | 0.2 | 0.2 | 0.3 |
| This Invention | Information Media No. 7 | Recording Media No. 7 | 0.1 | 0.2 | 0.2 | 0.3 |
| This Invention | Information Media No. 8 | Recording Media No. 8 | 0.1 | 0.2 | 0.2 | 0.3 |
| This Invention | Information Media No. 9 | Recording Media No. 9 | 0.1 | 0.2 | 0.2 | 0.3 |
| Comparative Example | Information Media No. 10 | Recording Media No. 10 | 0.1 | 0.2 | 0.2 | 0.3 |
| Comparative Example | Information Media No. 11 | Recording Media No. 11 | 0.1 | 0.2 | 0.3 | 0.4 |
| This Invention | Information Media No. 12 | Recording Media No. 12 | 0.1 | 0.2 | 0.3 | 0.4 |
| This Invention | Information Media No. 13 | Recording Media No. 13 | 0.1 | 0.2 | 0.3 | 0.4 |
| This Invention | Information Media No. 14 | Recording Media No. 14 | 0.1 | 0.2 | 0.3 | 0.4 |
| This Invention | Information Media No. 15 | Recording Media No. 15 | 0.1 | 0.2 | 0.3 | 0.4 |
| This Invention | Information Media No. 16 | Recording Media No. 16 | 0.1 | 0.2 | 0.3 | 0.4 |
| This Invention | Information Media No. 17 | Recording Media No. 17 | 0.1 | 0.2 | 0.3 | 0.4 |
| This Invention | Information Media No. 18 | Recording Media No. 18 | 0.1 | 0.2 | 0.3 | 0.4 |
| This Invention | Information Media No. 19 | Recording Media No. 19 | 0.1 | 0.2 | 0.3 | 0.4 |
| Comparative Example | Information Media No. 20 | Recording Media No. 20 | 0.1 | 0.2 | 0.4 | 0.5 |
| This Invention | Information Media No. 21 | Recording Media No. 21 | 0.1 | 0.2 | 0.3 | 0.4 |
| This Invention | Information Media No. 22 | Recording Media No. 22 | 0.1 | 0.2 | 0.3 | 0.4 |
| This Invention | Information Media No. 23 | Recording Media No. 23 | 0.1 | 0.2 | 0.3 | 0.5 |

From the above table it can be seen that storage stability is favorable for the holographic information media of this invention compared to that of the comparative example, without reduction of sensitivity for reproduction, and in addition, favorable results in with little coloration is seen.

(Evaluation of the Holographic Information Media 2)

The holographic recording media which were created in Table 4 and on which recorded information is fixed are used as holographic information media and some of these are subjected to deformation and drop testing and then evaluated. Reproduction of the digital pattern is evaluated by a method suitable for the respective information media for media in which changes in outer appearance and deformation were not seen immediately after testing and the difference after storage for the minimum amount of exposure for which favorable reproduction of the digital pattern was possible was evaluated. The obtained results are shown in Table 6.

(Resistance to Deformation Stress)

Both ends of the holographic information media were fixed and vibrated such that there were 28,000 rotations per minute at the middle portion and displacement was ±0.4 mm in the perpendicular direction of the information media, and the difference in minimum exposure sensitivity (ΔSb) immediately after application of the deformation stress is obtained.
Difference in minimum exposure sensitivity (ΔSb)=minimum exposure sensitivity after application of the deformation stress of vibration (S2b)−minimum exposure sensitivity prior to application of the deformation stress of vibration (S1b)

(Impact Resistance)

Holographic information media having a thickness of 10 mm is dropped from a height of 1 m on a rubber sheet having a thickness of 80 degrees when measured by a ISO 868 type A durometer, such that the information media and the rubber sheet are parallel and perpendicular to each other, and minimum exposure sensitivity immediately after the dropping is determined.
Difference in parallel drop test minimum exposure sensitivity (ΔSd1)=minimum exposure sensitivity after parallel drop test (S2d1)−minimum exposure sensitivity prior to parallel drop test (S1d1)
Difference in perpendicular drop test minimum exposure sensitivity (ΔSdp)=minimum exposure sensitivity after perpendicular drop test (S2dp)−minimum exposure sensitivity prior to perpendicular drop test (S1dp)

TABLE 6

| | | | Deformation | | Impact Resistance | | | |
|---|---|---|---|---|---|---|---|---|
| | | | Stress | | Parallel | | Perpendicular | |
| | Holographic | Holographic | Resistance | | drop test | | drop test | |
| | Information | Recording | Outer | ΔSb | Outer | ΔSb1 | Outer | ΔSbp |
| | Media No. | Media No. | Appearance | [mJ/cm²] | Appearance | [mJ/cm²] | Appearance | [mJ/cm²] |
| Comparative Example | Information Media No. 1 | Recording | *1 | *4 | *1 | — | *1 | *4 |
| | | Media No. 1 | | | | | | |
| This Invention | Information Media No. 2 | Recording | OK | 0.0 | OK | 0.0 | OK | 0.0 |
| | | Media No. 2 | | | | | | |
| This Invention | Information Media No. 3 | Recording | OK | 0.0 | OK | 0.0 | OK | 0.0 |
| | | Media No. 3 | | | | | | |
| This Invention | Information Media No. 4 | Recording | OK | 0.0 | OK | 0.0 | OK | 0.0 |
| | | Media No. 4 | | | | | | |
| This Invention | Information Media No. 5 | Recording | OK | 0.0 | OK | 0.0 | OK | 0.0 |
| | | Media No. 5 | | | | | | |
| This Invention | Information Media No. 6 | Recording | OK | 0.0 | OK | 0.0 | OK | 0.0 |
| | | Media No. 6 | | | | | | |
| This Invention | Information Media No. 7 | Recording | OK | 0.0 | OK | 0.0 | OK | 0.0 |
| | | Media No. 7 | | | | | | |
| This Invention | Information Media No. 8 | Recording | OK | 0.0 | OK | 0.0 | OK | 0.0 |
| | | Media No. 8 | | | | | | |
| This Invention | Information Media No. 9 | Recording | OK | 0.0 | OK | 0.0 | OK | 0.0 |
| | | Media No. 9 | | | | | | |
| Comparative Example | Information Media No. 10 | Recording | OK | *3 | OK | 0.0 | OK | 0.0 |
| | | Media No. 10 | | | | | | |
| Comparative Example | Information Media No. 11 | Recording | *1 | *4 | *2 | — | *2 | *4 |
| | | Media No. 11 | | | | | | |
| This Invention | Information Media No. 12 | Recording | OK | 0.0 | OK | 0.0 | OK | 0.0 |
| | | Media No. 12 | | | | | | |
| This Invention | Information Media No. 13 | Recording | OK | 0.0 | OK | 0.0 | OK | 0.0 |
| | | Media No. 13 | | | | | | |
| This Invention | Information Media No. 14 | Recording | OK | 0.0 | OK | 0.0 | OK | 0.0 |
| | | Media No. 14 | | | | | | |
| This Invention | Information Media No. 15 | Recording | OK | 0.0 | OK | 0.0 | OK | 0.0 |
| | | Media No. 15 | | | | | | |
| This Invention | Information Media No. 16 | Recording | OK | 0.0 | OK | 0.0 | OK | 0.0 |
| | | Media No. 16 | | | | | | |
| This Invention | Information Media No. 17 | Recording | OK | 0.0 | OK | 0.0 | OK | 0.0 |
| | | Media No. 17 | | | | | | |
| This Invention | Information Media No. 18 | Recording | OK | 0.0 | OK | 0.0 | OK | 0.0 |
| | | Media No. 18 | | | | | | |
| This Invention | Information Media No. 19 | Recording | OK | 0.0 | OK | 0.0 | OK | 0.0 |
| | | Media No. 19 | | | | | | |
| Comparative Example | Information Media No. 20 | Recording | OK | *3 | OK | 0.0 | OK | 0.0 |
| | | Media No. 20 | | | | | | |

*1 There is very little cracking of the information recording layer
*2 The first substrate glass is broken
*3 Evaluation impossible because reproduction was could not be performed on the hologram after deformation stress was applied
*4 Evaluation was not done since problems with respect to outer appearance were evident

From the table above, it can be seen that there are no changes in outer appearance the holographic information media of this invention even when unanticipated stress is applied thereto, and favorable results without sensitivity reduction are seen when compared with those of the comparative example.

What is claimed is:

1. A holographic recording medium comprising:
an first substrate;
a holographic recording layer in which information can be holographic-recorded by entering information light and reference light from the first substrate side; and
a second substrate, in that order,
wherein the holographic recording medium satisfies the following relationship of (1) and (2):
0.2≦Dh/(D1+D2)≦1.0 (1)
1.0≦(Dh+D1+D2)≦3.0 [mm], (2)
in the (1) and (2) D1 is the thickness of the first substrate, D2 is the thickness of the second substrate, and Dh is the thickness of the holographic recording layer, and wherein a hardness of the holographic recording layer that is measured by ISO 868 type A durometer is 10-70 degrees.

2. The holographic recording medium of claim 1, wherein the holographic recording layer comprises a binder forming compound, a photopolymerizable compound which has a functional group being capable of photopolymerization and a photopolymerization initiator which can initiate a polymerization reaction of the photopolymerizable compound.

3. The holographic recording medium of claim 2, wherein the photopolimerizable compound is liquefied and the photopolimerizable compound has a melting point is less not more than 60° C. and the functional group being capable of photopolymerization is ethyleny unsaturated bonding.

4. The holographic recording medium of claim 2, wherein the refractive index of a binder formed by the binder forming compound is not more than a refractive index of a polymerized compound formed by polymerization of the photopolymerizable compound having the functional group being capable to photopolymerize.

5. The holographic recording medium of claim 2, wherein the hardness of the holographic recording layer measured with the durometer of type A specified by ISO 868 after carrying out photopolymerization of the photopolymerizable compound in the holographic recording layer is 15-80 degrees.

6. The holographic recording medium of claim 1, wherein an antireflection layer that the reflectance to the wavelength of information light and reference light is 0.01-1.0% is provided on the surface side which enters the information light and reference light of the first substrate.

7. The holographic recording medium of claim 6, wherein an antireflection layer that the reflectance to the wavelength of information light and reference light is 0.01-1.0% is provided on the surface side of the second substrate.

8. The holographic recording medium of claim 1, wherein at least one surface of the second substrate is covered with a reflection layer having a reflectance of 80-99.9%.

9. The holographic recording medium of claim 8, wherein the holographic recording layer comprises a binder forming compound, a photopolymerizable compound which has a functional group being capable of photopolymerization and a photopolymerization initiator which can initiate a polymerization reaction of the photopolymerizable compound.

10. The holographic recording medium of claim 2, wherein the photopolymerizable compound is liquefied and the photopolymerizable compound has a melting point is less not more than 60° C. and the functional group being capable of photopolymerization is ethyleny unsaturated bonding.

11. The holographic recording medium of claim 9, wherein the refractive index of a binder formed by the binder forming compound is not more than a refractive index of a polymerized compound formed by polymerization of the photopolymerizable compound having the functional group being capable to photopolymerize.

12. The holographic recording medium of claim 9, wherein the hardness of the holographic recording layer measured with the durometer of type A specified by ISO 868 after carrying out photopolymerization of the photopolymerizable compound in the holographic recording layer is 15-80 degrees.

13. The holographic recording medium of claim 8, wherein an antireflection layer that the reflectance to the wavelength of information light and reference light is 0.01-1.0% is provided on the surface side which enters the information light and reference light of the first substrate.

14. A holographic recording method for recording information on the holographic recording medium of claim 2, comprising:
reacting the binder forming compound for forming a binder;
holographic exposing a surface of the anti-reflection layer of the holographic recording medium based on the information for generating activated species by activating the photopolymerization initiator; and
diffusion polymerizing the photopolymerizable compound by the activated species in the holographic recording layer.

15. The holographic recording method of claim 14, further comprising:
stabilizing the information by heating or photoirradiating the holographic recording medium.

16. A holographic information medium comprising:
an first substrate;
a holographic information recording layer containing a binder area containing the binder as major component formed by reacting a binder forming compound and a photopolymerized area containing a photopolymerized compound a major component formed by photopolymerizing a compound which has a functional group being capable of photopolymerization, and a refractive index of the binder area is lower than a refractive index of the photopolymerized area;
a second substrate, in that order,
wherein the holographic recording medium satisfies the following relationship of (1) and (2):
0.2≦Dh/(D1+D2)≦1.0 (1)
1.0≦(Dh+D1+D2)≦3.0 [mm], (2)
in the (1) and (2), D1 is the thickness of the first substrate, D2 is the thickness of the second substrate, and Dh is the thickness of the holographic recording layer, and wherein a hardness of the holographic recording layer that is measured by ISO 868 type A durometer is 15-80 degrees.
